(19) United States
(12) Patent Application Publication
(10) Pub. No.: US 2008/0006598 A1
(43) Pub. Date: Jan. 10, 2008

(54) Heat Insulated Container And Manufacturing Method Thereof

(75) Inventors: Takafumi Fujii, Tsubame-shi (JP); Yu Kobayashi, Tsubame-shi (JP)

Correspondence Address: DARBY & DARBY P.C., P.O. BOX 770, Church Street Station, New York, NY, 10008-0770, US

(73) Assignee: THERMOS K.K., Niigata (JP)

(21) Appl. No.: 11/720,533

(22) PCT Filed: Mar. 28, 2005
(86) PCT No.: PCT/JP05/05716

§ 371 Date: May 31, 2007

(51) Int. Cl. A47J 41/02

(52) U.S. Cl. 215/12.1; 65/25.1

(57) ABSTRACT

A heat insulated container preventing a pad from scratching the side surfaces of containers, from peeling off a radiation preventing film and from creating a heat transfer path that promotes heat transfer. The heat insulated container is formed as follows: interposing a positioning jig between an internal container and an upper external container member of an external container comprising the upper external container member and a lower external container member to form a gap of a preset dimension therebetween; joining together an opening of the upper external container member and the opening of the internal container and removing the positioning jig from the gap; and then joining together the upper external container member and the lower external container member and evacuating the gap between the external container and the internal container to a vacuum and sealing the same.

### CROSS REFERENCE TO RELATED APPLICATIONS

This is a U.S. national phase application under 35 U.S.C. § 371 of International Patent Application No. PCT/JP2005/005716, filed Mar. 28, 2005. The International Application was published in Japanese on Oct. 5, 2006 as International Publication No. WO 2006/103729 under PCT Article 21(2), the content of which is incorporated herein in their entireties.

### TECHNICAL FIELD

The present invention relates to a heat insulated container and a manufacturing method thereof, and more specifically, relates to a glass heat insulated container formed by joining an internal container with an external container and evacuating a gap therebetween to a vacuum, and a manufacturing method thereof.

### BACKGROUND ART

Heretofore, a glass heat insulated container has been produced by the following various methods (Japanese unexamined patent application publication No. 2002-58605).

FIG. 3 (A) illustrates a first conventional method. According to this conventional method, firstly formed are an internal container 100 provided at its top with an opening 100a and a cylindrical external container 102 approximately similar to the internal container 100 and having an opening 102a at its top and an exhaust tip tube 104 at its bottom. With a uniform gap 108 being kept between the internal container 100 and the external container 102 by interposing a pad 106 at the bottom, the internal container 100 is inserted into the external container 102 from the lower opening 102b of the external container 102 so that the internal container 100 is housed in the external container 102. Next, the diameter of the opening 102a of the external container 102 is reduced to form an opening of the external container by spinning process in which the side of the opening 102a is pressed using a press-contact jig such as a paddle or the like with the side of the opening 102a being heated and rotated. Then, a double-walled container is formed by welding the opening 100a of the internal container to the opening of the external container, and then the gap 108 is evacuated to a vacuum through the exhaust tip tube 104 and sealed to thereby produce a heat insulated container.

FIG. 3(B) illustrates a second conventional method. According to this method, firstly formed are an internal container provided at its top with an opening 100a and an external container 112 approximately similar to the internal container 100 and provided with an opening 112a at its top and an opening 112b at its bottom. A gap 108 is kept uniform between the internal container 100 and the external container 112 by interposing the pad 106, and the internal container 100 is inserted into the external container 112 from the lower opening 112b of the external container 112 to thereby house the internal container 100 in the external container 112. Then, the opening 100a of the internal container 100 and the opening 112a of the external container are heated to weld both the openings to each other. Further, the lower opening 112b of the external container 112 is pulled downward, using a pulling jig 114 while rotating the same with a peripheral side thereof being heated, thereby reducing the opening 112b in diameter to form its bottom. After that, a hole is formed through the bottom, and the exhaust tip tube is welded to the bottom to thereby form a double-walled container. Like in the above-mentioned conventional method 1, a heat insulated container is produced by evacuating the gap to a vacuum and then sealing the same.

FIG. 3(C) illustrates a third conventional method. According to the method, firstly, formed are an external container 122 and an internal container 100 such that that the external container 122 may comprise two separate portions one of which is an upper external container member 124a provided with an opening 122a at its top and an opening 122b at its bottom and the other of which is a lower external container member 124b provided with an exhaust tip tube 104 at its bottom, while the internal container 100 may be formed approximately similar in shape to the internal container 122 and provided with an opening 100a at its top. Then, a gap 108 is kept uniform by interposing a pad 106 between the internal container 100 and the upper external container member 124a, and the internal container 100 is housed in the upper external container member 124a by inserting the internal container 100 from the lower opening 122b of the upper external container member 124a. Next, after heating and welding together the opening 100a of the internal container 100 and the opening 122a of the external container 122, the upper external container member 124a and the lower external container member 124b are welded to be unified together, thus forming a double-walled container. Then, like in the above-mentioned method, a heat insulated container is produced by evacuating the gap 108 to a vacuum and sealing the same.

### SUMMARY OF THE INVENTION

In either method, however, the pad 106 is placed between the internal container 100 and the external containers 102, 112 and 122 in order to keep a preset gap therebetween. As a material for the pad 106, asbestos has conventionally been used, which, however, have had adverse effects on the environment and health.

For this reason, substitute materials have been used, which, however, are slightly harder and less elastic than asbestos. Therefore, they are not able to meet a varying width of a gap between the internal and external containers during a production process, thus occasionally resulting to displacement of the pad or development of a stress in a portion between the internal container and the external container where the pad is sandwiched. When the pad thus displaced is moved so as to be restored to an appropriate position, scratches are sometimes produced on the sides of the internal and the external containers, and specifically in the case that they are coated with a radiation preventing film, the radiation preventing film may be peeled off, and thus the heat insulation capacity may be adversely affected.

Further, if a pad exists when coated with a transparent radiation preventing film to make an exterior transparent, the pad becomes visible, which is not desirable in terms of appearance. Furthermore, there is a problem that due to the existence of the pad, a heat transfer path is created and thus heat transfers through the pad between the internal container and the external container, so that the heat insulation capacity deteriorates.

The present invention has been made to solve these problems, and it is an object of the present invention to prevent the pad from scratching the side surfaces of containers, from peeling off a radiation preventing film, and from creating a heat transfer path that promotes heat transfer, while ensuring good appearance.

A heat insulated container of the present invention is one formed by joining an internal container with an external container and evacuating a gap therebetween to a vacuum and sealing the same, wherein the internal container and the external one are united only by joining openings thereof.

A manufacturing method of the heat insulated container of the present invention comprises: interposing a positioning jig between an internal container and an upper external container member of an external container comprising the upper external container member and a lower external container member to form a gap of a preset dimension therebetween; joining together an opening of the upper external container member and an opening of the internal container and removing the positioning jig from the gap; and then joining together the upper external container member and the lower external container member and evacuating a gap between the external container and the internal container to a vacuum and sealing the same.

According to the heat insulated container of the present invention, the internal container and the external container are unified only by joining the respective openings thereof. In other words, because there is no pad interposed between the internal container and the external container, no scratches or scratches on the sides of the external and internal containers are formed by the pad. Further, because the pad is not visible from the exterior, appearance of the heat insulated container is not impaired. Further, because the coated radiation preventing film is not peeled off by the pad and no heat transfer path is created by the pad, heat retaining effect is not damaged.

According to the method for manufacturing a heat insulated container of the present invention, a preset width of a gap is kept between the external container and the internal container by using the positioning jig, and thus the heat insulated container is manufactured without using any pad. Thus, due to no scratches being formed on the sides of the external and internal containers during the production process, the appearance of the heat insulated container is not impaired. Further, because the coated radiation preventing film is not peeled off by the pad and no heat transfer path is created by the pad, the heat-retention effect is not damaged.

### BRIEF DESCRIPTION OF THE DRAWING

FIG. 1 is a cross sectional view showing a heat insulated container according to a preferred embodiment of the present invention.

FIG. 2 generally shows a production process for the heat insulated container according to the preferred embodiment of the present invention, in which FIG. 2(A) is a view showing a positioning jig being interposed between an upper external container member and an internal container,

FIG. 2(B) is a view showing openings of the containers having been joined together,

FIG. 2(C) is a view illustrating a lower external container member being inserted, and

FIG. 2(D) is a view showing the heat insulated container completed by joining together the upper external container member and the lower external container member, respectively.

FIG. 3 generally shows a conventional art, in which FIG. 3(A) shows a first conventional art,

FIG. 3(B) shows a second conventional art, and

FIG. 3(C) shows a third conventional art, respectively.

### DETAILED DESCRIPTION OF THE INVENTION

Hereunder, an embodiment of the present invention is described with reference to the attached drawings.

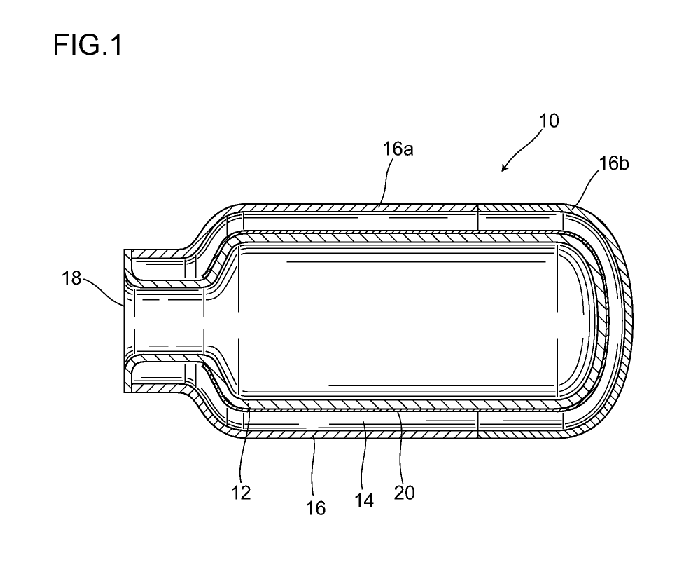

FIG. 1 is a cross sectional view showing a heat insulated container 10 according to an embodiment of the present invention. As shown in the drawings, the heat insulated container 10 of the present embodiment comprises a glass internal container 12 and a glass external container 16 which is arranged at the outside of the internal container 12 with a gap 14 of a preset width therebetween. The external container 16 is formed by joining together an upper external container member 16a and a lower external container member 16b. The internal container 12 and the upper external container member 16a are joined together at an opening 18, and the gap 14 between an inner surface of the external container 16 and an outer surface of the internal container 12 is kept in a vacuum condition. Further, no pad or the like is interposed between the internal container 12 and the external container 16, and the internal container 12 and the external container 16 are joined together only by joining them at the opening 18.

To decrease a heat radiation, the outer surface of the internal container 12a is coated with a see-through radiation preventing film 20. Although the outer surface of the internal container 12 is coated with the heat radiation preventing film 20 in the present embodiment, coating surface should not be limited thereto, but any other surface, for example, the inner surface of the external container 16 or the like may be coated. Further, although the use of an ITO film (a substance obtained by doping an indium (In) oxide with tin (Sn)) is proposed for the radiation preventing film 20, the material of the radiation preventing film is not limited thereto, but metal oxides (semiconductor materials) such as ZnO, SiOx, SnO2, or TiOx, may be used.

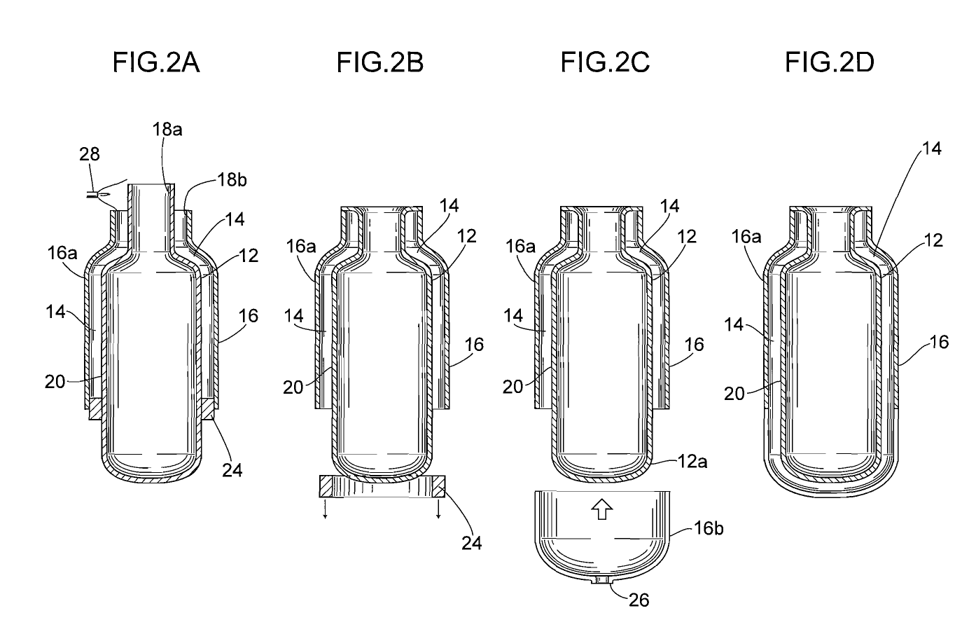

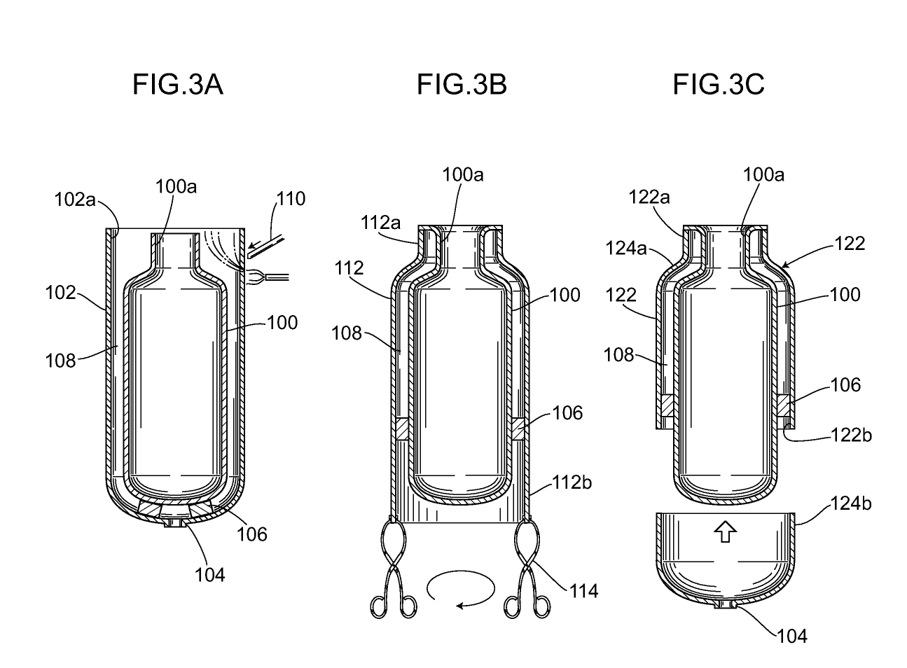

Next, a method for manufacturing the heat insulated container 10 is explained with reference to FIG. 2. First, the internal container 12 is molded in a desired shape, and the external container 16 is formed which is approximately similar to that of the internal container 12. At this time, the external container 16 is fabricated by providing two separate members: the upper external container member 16a including the opening 18b and the lower external container member 16b provided with an exhaust tip tube 26 at the bottom, as shown in FIG. 2(C). Then, the outer surface of the internal container 12 is coated with the above-mentioned radiation preventing film 20.

Subsequently, as shown in FIG. 2(A), the internal container 12 is arranged inside the upper external container member 16a in such a manner that the opening 18a of the internal container 12 protrudes from the opening 18b of the external container 16. At this time, a positioning jig 24 is fitted into the lower part of the internal container 12 from the lower part thereof, to thereby interpose the jig 24 between the internal container 12 and the upper external container member 16a. The positioning jig 24 is a cylindrical member whose thickness is approximately equal to the width of the gap 14. The inside diameter of the positioning jig 24 is slightly larger than the outside diameter of the internal container 12, and the outside diameter thereof is slightly smaller than the internal diameter of the upper external container member 16a. Thus, the positioning jig 24 can keep the gap 14 of a preset width between the internal container 12 and the upper external container member 16a.

Next, the internal container 12 is rotated while heating the openings 18 of the internal container 12 and the upper external container member 16a by a burner 28, and thus an all-around portion of the opening 18 of the internal container 12 is melted, thereby integrally joining the opening 18a of the internal container 12 to the opening 18b of the external container 16.

Here, when the opening 18a of the internal container 12 and the opening 18b of the external container 16 are heated at the time of this welding, the bodies of the internal container 12 and the external container 16 expand slightly and then shrink as they are cooled. At this time, due to a difference in shrinkage of welded parts, displacement is often caused. Further, due to a slight difference in thickness or in heating condition, the degrees of expansion and shrinkage sometimes become nonuniform. According to the present embodiment, however, because the positioning jig 24 is interposed between the internal container 12 and the upper external container member 16a, the width of the gap 14 can be kept at a fixed value despite the non-uniformity of the expansion or the shrinkage.

Next, after the container is cooled and the width of the gap 14 is fixed, the positioning jig 24 is taken out of the lower part of the internal container 12 as shown in FIG. 2 (B). As is apparent from the foregoing, according to the present embodiment, because the positioning jig 24 is removed and dose not remain in the inside of the finished heat insulated container 10, any raw material for the positioning member can be selected freely. Therefore, the positioning member can be made from a material having an appropriate elasticity which can meet a varying width of the gap 14 that occurs in the case of heating and cooling the internal and external containers 12, 16. Accordingly, by making the positioning jig from such material, no excessive stress is developed in any portion of the internal and external containers 12, 16 that supports the positioning jig 14 by sandwiching the same therebetween. Further, when the positioning jig 24 is removed from the gap 14, no scratching is formed on the internal and external containers, and no adverse effect on the heat insulation performance is caused by the peeling of the radiation preventing film 20. Further, because a heat transfer path is not created between the internal and external containers 12, 16, heat insulation performance is not deteriorated.

Then, as shown in FIG. 2 (C), the lower external container member 16b is arranged, following an arrow in the drawing, in a manner enclosing the lower part 12a of the internal container from the lower part 12a of the internal container. Thus, the upper external container member 16a and the lower external container member 16b are welded to be joined together to form a double-walled container.

Finally, the gap 14 is evacuated via the exhaust tip tube 26 to a predetermined degree of vacuum, for example to 133.3×10−3 Pa or below, and then the exhaust tip tube 26 is welded to thereby seal the container in a vacuum.

As mentioned above, according to the present embodiment, there is provided the heat insulated container 10 in which the internal container 12 and the external container 16 are joined together, and the gap 14 between the internal container 12 and the external container 16 is evacuated to a vacuum and sealed, wherein the internal container 12 and the external one 16 are integrated together only by joining the opening 18.

According to the heat insulated container 10, the internal container 12 and the external container 16 are integrated only by the opening 18. That is to say, because no pad is interposed between the internal container 12 and the external container 16, no scratches are formed on the sides of the internal container 12 and external container 16 by the pad. As a result, the appearance of the heat insulated container 10 is not deteriorated. Further, since the coated radiation preventing film 20 is not peeled off by the pad and no heat transfer path is created by the pad, heat-retention effect is not deteriorated.

Further, the heat insulated container 10 of the present invention is characterized in that the manufacturing method thereof comprises: interposing the positioning jig 24 between the internal container 12 and the upper external container member 16a of the external container 16 comprising the upper external container member 16a and the lower external container member 16b to form the gap 14 of a preset dimension therebetween; joining together the opening 18b of the upper external container member 16a and the opening 18a of the internal container 12 and removing the positioning jig 24 from the gap 14; and then joining together the upper external container member 16a and the lower external container member 16b and evacuating the gap between the external container 16 and the internal container 12 to a vacuum and sealing the same.

Accordingly, the gap 14 between the external container 16 and the internal container 12 can be kept at a preset interval by using the positioning jig 24, to thereby manufacture the heat insulated container 10 without using a pad. Thus, since no scratches are formed on the side of the internal container 12 and the external container 16 during the production process, the appearance of the heat insulating container 10 is not deteriorated. Further since the coated radiation preventing film 20 is not peeled by the pad, and besides no heat transfer path is created, the heat insulating effect is not deteriorated.

The preferred embodiment of the present invention has been described above, however the present invention is not limited to the embodiment, and can be modified variously.

1. A heat insulated container formed by joining a glass transparent internal container with a glass transparent external container and evacuating a gap therebetween to a vacuum and sealing the same, wherein said internal container and said external container are unified together only by joining openings thereof without interposing a pad.

2. A method for manufacturing a heat insulated container, comprising steps of:
interposing a positioning jig between a glass internal container and an upper external container member of a glass external container comprising the upper external container member and a lower external container member to form a gap of a preset dimension therebetween, said positioning jig being capable of meeting a varying width of the gap therebetween;
joining together an opening of the upper external container member and an opening of the internal container and removing the positioning jig from the gap; and
joining together the upper external container member and the lower external container member and evacuating a gap between the external container and the internal container to a vacuum and sealing the same.
